(19) United States
(12) Patent Application Publication
(10) Pub. No.: US 2019/0290071 A1
(43) Pub. Date: Sep. 26, 2019

(54) DEVICE FOR SEPARATING FAT OR OIL FROM SOUP BROTH DURING THE COOKING PROCESS

(71) Applicant: Ky Van Nguyen, Hayward, CA (US)

(72) Inventor: Ky Van Nguyen, Hayward, CA (US)

(21) Appl. No.: 15/927,094

(22) Filed: Mar. 21, 2018

(51) Int. Cl. A47J 43/28

(52) U.S. Cl. CPC A47J 43/285

(57) ABSTRACT

The Fat Separator Skimmer (FSS) is a ladle; it has an outlet hole in the bottom of the ladle, and a locker for opening and closing outlet hole. The locker close outlet hole to intake mixture liquid of soup and fat or oil by on the top of a bowl of the ladle, then open for soup drain off through outlet hole and it shut off to retain fat in the skimmer. Repeating this process allows for the accumulation of fat in the ladle that is later discarded.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

### Field of Invention

This invention, known as the Fat Separator Skimmer (FSS), relates to methods and devices for removing fat and oil out of broth or soup.

### Background

Currently, the common way that many cooks separate the layer of fat or oil on the surface of soup is by using a ladle to remove oil or fat from soup or broth. This results in some inconveniences because soup or broth gets discarded along with the fat or oil. The result is loss of broth or soup during this process. Another skimmer product looks like a cup with a tube in the bottom to drain off soup and retain fat in the cup. This type of skimmer takes soup into the cup and then separates oil and fat, but requires much more work. Another product called the “Fat and Lean Gravy Separator” looks like a ladle with a tube from the bottom to the mouth of ladle that also allows for too much soup to be lost.

### BRIEF SUMMARY OF INVENTION

The FSS is used to remove unwanted cooking oil or fat from soup base or broth. It can minimize the risk of soup loss during the cooking of soup and enables cooking chefs to remove unwanted cooking oil or fat are more easily. The purpose of the FSS is to minimize the loss of broth needed for more nutritious meals and make this work faster. With the goal of retaining more soup, the FSS has an outlet hole at the bottom of its reservoir bowl; the outlet hole can be closed or opened let soup drain out and retain fat and oil in the spoon, so that fat and oil can be separated from soup for later discarding.

### BRIEF DESCRIPTION OF SEVERAL VIEWS OF THE DRAWINGS

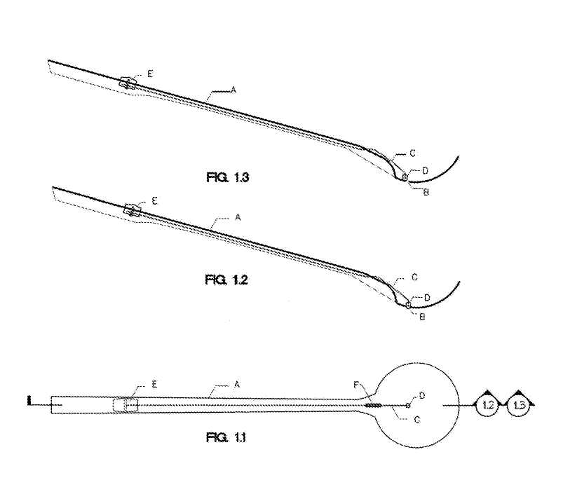

Drawing FIG. 1.1—Top view of the FSS with the close-open Locker Button feature

Drawing FIG. 1.2—Section (drain hole at closed position) of the FSS with the close-open Locker Button feature

Drawing FIG. 1.3—Section (drain hole at opened position) of the FSS with close-open Locker Button feature

### DETAILED DESCRIPTION OF THE INVENTION

This like a ladle, it has a locker button (E) on its ladle handle (A) attached to a connecting rod (C) with a stopper (D) that is manually operated to open or close access to the outlet drain hole (B). When the locker button (E) is manually pushed toward the reservoir bowl, the stopper (D) closes off the outlet drain hole (B) we can intake soup/fat mixture into the bowl via above the bowl. Then the FSS is raised out of the soup/fat mixture, and then we pull-back the locker button (E) to open access through the outlet drain hole (B), so the heavier soup broth can separate from the lighter fatty oil and flow out through the outlet drain hole (B). When the soup broth drains out, the outlet drain hole (B) is again shut off to retain the fatty oil within the reservoir bowl for later discarding.

Description of Operating Parts the FSS with Close-Open Locker Button Feature
A Ladle spoon handle
B Outlet drain hole at the bottom of the reservoir bowl
C Connecting rod, connecting the locker from button (E) to the oval shaped stopper (D)
D Oval-shaped stopper that close or open liquid flow through the outlet drain hole (B)
E Locker button on the ladle spoon handle that is manually operated to permit or prevent liquid flow through the outlet drain hole
F Slotted hole in Ladle Spoon Handle (A) to connecting rod goes through from under to above of the Ladle Spoon
   Method of Operation the FSS with Close-Open Locker Button Feature

First, the locker button (E) on the ladle spoon handle (A) is pushed in the direction of the reservoir bowl, so that the connecting rod can position the oval-shaped stopper (D) to close off access through the outlet drain hole (B). The FSS is lowered into a soup/fat mixture to gather the fat or oil liquid into the reservoir bowl and then the FSS is raised out of the soup mixture. Then the locker button (E) on the ladle spoon handle (A) is pushed in the direction away from the reservoir bowl so that the connecting rod can allow the oval-shaped stopper (D) to open access through the outlet drain hole (B). The heavier soup broth can separate from the lighter fatty oil and flow out through the outlet drain hole (B). After all of the soup, broth drains out, the outlet drain hole (B) is again shut off to retain the fatty oil within the reservoir bowl. This process is repeated until all the fatty oil is accumulated on the wall of the reservoir bowl for later discarding.

### DRAWINGS

Drawing Figure the FSS with Close-Open Locker Button Feature

FIG. 1.1, FIG. 1.2, FIG. 1.3
A Ladle Spoon Handle
B Outlet Drain Hole
C Connecting Rod
D Oval-Shaped Stopper
E Locker Button
F Slotted hole in Ladle Spoon Handle (A)

1) Methods or devices that facilitate separation a light liquid as oil or fat from the heavy liquid as water, broth or soup by use of control mechanisms to control the outlet hole at the bottom of reservoir bowl for heavy liquid drain off and a locker for retaining a light liquid in the reservoir bowl for later discarding.

2) Method or device that permits separation of light from heavy liquids by use of a control mechanism noted under claim 1) wherein said closing-opening control function is activated by manually moving a locker button located on the ladle handle that connects via a connecting rod to an oval-shaped stopper positioned over the outlet drain hole at the bottom of the reservoir bowl that permits or prevents flow of liquid through the outlet drain hole.
